(19) United States
(12) Patent Application Publication
(10) Pub. No.: US 2007/0083303 A1
(43) Pub. Date: Apr. 12, 2007

(54) Marketplace for vehicle original equipment manufacturer information

(75) Inventors: Albert G. O'Sullivan, County Cork (IE); Jamie G. Kelly, County Cork (IE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Snap-on Incorporated

(21) Appl. No.: 11/247,473

(22) Filed: Oct. 11, 2005

(51) Int. Cl. G01M 17/00

(52) U.S. Cl. 701/29

(57) ABSTRACT

A system, apparatus and method for providing vehicle information to a vehicle-diagnostic system (VDS) is provided. The VDS may use the vehicle information provided by the system to process vehicle diagnostic data associated with an operation of a vehicle. The system includes a network server being adapted to (i) receive from a vehicle-diagnostic system a first request for particular vehicle information; (ii) provide to an information-retrieval engine the first request; (iii) receive from the information-retrieval engine an indication as to whether the particular vehicle information has been located; (iv) receive from the information-retrieval engine the particular vehicle information; and (v) provide to the vehicle-diagnostic system the particular vehicle information.

### BACKGROUND

1. Field

The present disclosure relates to the field of vehicle-diagnostic systems. More specifically, the present disclosure relates to a searchable marketplace for retrieving vehicle original equipment manufacturer specifications and diagnostic information.

2. Description of the Related Art

About thirty five or so years ago, transportation vehicle manufacturers instituted on-board vehicle diagnostics (“OBD”) systems to assist in diagnosing failures of control and monitoring systems of the vehicles manufactured by them. To do this, the OBD systems typically generate vehicle data that can be used to carry out the diagnostics of the command, control and monitoring systems of the vehicle (hereinafter referred to as “vehicle systems”). The OBD systems are generally integrated into, integral to or otherwise combined with the vehicle systems that the OBD systems are intended to diagnose. The OBD systems, however, may be deployed separate from any of the vehicle systems.

While the earliest OBD systems did not conform to any standard protocol and varied greatly from one vehicle manufacturer to another, some (and later most) North American vehicle manufacturers in the mid-1980's adopted a standard protocol for OBD, namely OBD-I. For a myriad of reasons, including, for example, being able to provide additional monitoring and reporting services, many vehicle manufacturers adopted a second generation of the OBD protocol, namely OBD-II, for diagnosing failures of the vehicle systems.

Like its predecessors, the OBD-II protocol specifies that various parameters of vehicle operation, such as vehicle-emissions parameters, are to be available for diagnostics and command-and-control purposes. The OBD-II protocol also provides standardized rules for monitoring and reporting malfunctions with vehicle operation. For example, when a malfunction is detected by an OBD system that complies with OBD-II, then that OBD system may alert the vehicle systems by providing vehicle data, which includes n indication of the malfunction. This indication may then be used by the vehicle systems for reporting the malfunction. Reporting the malfunction may be carried out in a number of ways including, for example, illuminating a malfunction-indicator lamp (“MIL”), which is sometimes embodied as the well-known “Check Engine” light.

In addition, the OBD-II protocol also specifies that diagnostic-error codes and other vehicle data (hereinafter collectively referred to as “vehicle data”) are to be stored for a period of time. This way, a vehicle-maintenance technician, other person and/or machine (collectively referred hereinafter to as “user”) can access the vehicle data at a later time. This vehicle data may be used to assist in diagnosing the cause of the malfunction even if the malfunction is no longer occurring.

To facilitate such diagnostics, monitoring, reporting and storage of vehicle data, the OBD system typically includes a device for obtaining, storing and/or analyzing the vehicle data, commonly referred to as an “OBD device,”. The OBD device may be embodied in a combination of hardware, software, and/or firmware, and may be a stand-alone device (or number of devices). Alternatively, the OBD device may be integrated into, integral to or otherwise combined with the portions of the vehicle systems.

In either case, the OBD device may be adapted to (i) communicate with the vehicle systems to retrieve or otherwise obtain vehicle data generated by the OBD, and (ii) communicate the retrieved vehicle data to user of the OBD system. A user may tap into this valuable resource of information provided by the OBD system using a diagnosis and command-and-control (“DCC”) device that is capable of interfacing with the OBD device.

For example, the OBD device may be adapted to monitor vehicle data generated by the OBD system for errors that occur during normal operation of the vehicle. And if such errors occur, then the OBD device may record and/or report the vehicle data to the user. The vehicle data can be downloaded to or otherwise obtained by the DCC device when, for example, the vehicle is later serviced or otherwise queried. After receipt, the vehicle data may then be presented to the user in an appropriate fashion via a user interface of the DCC device. The user interface may present the vehicle data in any number of ways, including for example, a format in accordance with the OBD-I and/or OBD-II protocols.

At present, there are known DCC devices that are able to tap into the valuable resource of information provided by the OBD system. These DCC devices can vary from simple to sophisticated computing devices, some of which are commonly called scan or diagnostic tools. Included among the more sophisticated DCC devices are the Modular Diagnostic Information System (“MODIS™”) and the diagnostic scanner controller system MT2500™, both of which are manufactured and licensed for use by the present assignee. Details of exemplary DDC devices may be found in (i) U.S. Pat. Nos. 6,892,216; 6,845,307; 6,714,846; 6,693,367; 6,615,120; 6,564,128; 6,560,516; 6,512,968; 6,477,478; 6,141,608; and 6,029,508; and (ii) U.S. Patent Application Publication Ser. Nos. US20050096805; US20050075768A1; US20050085963; US20050027403A1; US20040172177A1; US20040003050A1; and US20030020759A1; all of which are assigned to the present assignee (or subsidiary thereof) of the present and incorporated herein by reference.

In addition to its processing abilities, each of the DCC devices employs logic and content, such as parametric and/or characteristic data, for analyzing the vehicle data received from the OBD system. In this manner, when a user attempts to analyze a condition of the vehicle, such DCC device may (i) obtain vehicle data, such as a diagnostic-error code, from the OBD system, and then (ii) process the diagnostic-error code as a function of the content so as to provide to the user an analysis of the condition of the vehicle. Accordingly, each of the DCC devices can dramatically reduce the time for servicing and/or making of reparations to the vehicle, thereby, reducing the labor-repair costs and increasing vehicle owner satisfaction and convenience.

Since the introduction of OBD systems, vehicles and their corresponding onboard-vehicle systems have increasingly become, and if history serves as an indicator the future, will continue to become substantially more complex; adding more components and functions carried out thereby. This growing complexity of the vehicles and their corresponding vehicle systems increasingly compounds a likelihood of malfunction of such vehicles and vehicle systems. This is because the probability of failure of the components, functions and interactions necessarily increases as a function of the increase in the number of such components, functions and interactions. Accordingly, DCC devices are presently and will continue to be indispensable in the practice of vehicle maintenance and repairs.

Nonetheless, economic infeasibility and computing platform restrictions generally prevents every one (if not any one) of the aforementioned DCC devices from containing all of the logic and/or content (collectively referred to hereinafter as “information”) for analyzing the vehicle data for every vehicle that uses an OBD system. This is because the information for analyzing vehicle data is often sold by vehicle make, make and/or model year, and purchasing all the information for all (or even a significant subset of) possible vehicle makes and models is generally cost prohibitive.

In addition, even if a DCC device possesses all available information for analyzing vehicle data for a given vehicle or set of vehicles at a given point in time, the DCC device may not possess information for analyzing the vehicle data that was released after that point in time. This not so infrequent situation can happen when, for example, the OBD device or its firmware version was not available or was updated after the given point in time. The same situation may occur when as noted, the information possessed by the DCC device does not include information for analyzing the vehicle data of a particular (e.g., a new) model year of the given vehicle or set of vehicles.

Moreover, some of the DCC devices do not possess the ability to store on board in non-volatile form any of the information for analyzing the vehicle data. Thus, such information has to be loaded into each of these diagnostic tools each time the tool is to be used. To load the information, many of these diagnostic tools use a removably-insertable cartridge or other memory module that is programmatically configured with the information. And for the same reasons as above, the cartridge or other memory module may not be programmatically configured with the information for analyzing the vehicle data of the given vehicle or set of vehicles.

As can be readily discerned from the foregoing, when the DCC device lacks information for analyzing vehicle data for a particular condition, the tool becomes useless for carrying out any part of the analysis and/or repair of a vehicle until the tool obtains the lacking information. Obtaining the lacking information, however, has been a time-consuming and arduous undertaking. For example, obtaining the lacking information may take days or even weeks given that the time between placing an order for and delivery of the lacking information may be days or even weeks. Moreover, many times a trained, programming specialist is required to install the lacking information, and such trained, programming specialist may not be readily available.

The task of obtaining the lacking information for the DCC device becomes more problematic when considering that manufacturers of DCC devices have an economical interest in ensuring a profit on providing the information for analyzing vehicle data. To ensure profitability, many of the DCC devices are designed and programmed according to one or more proprietary formats, which thereby limits the sources from which the lacking information may be purchased and/or obtained. In addition, as noted above, the information for analyzing vehicle data is often sold by vehicle make, model and/or model year, and is generally available as an all or nothing proposition, and not on a piecemeal basis.

Thus, when a DCC device obtains specific set, particular part or otherwise select-vehicle data associated with an operation of the vehicle (collectively referred to hereinafter as “select-vehicle data”), and then ascertains that it lacks information for analyzing the select-vehicle data, not only does the DCC device become useless for analyzing and repairing the vehicle, but also, the owner of the DCC device is saddled with potentially paying for more information than needed to analyze the select-vehicle data.

Therefore, what is needed is an apparatus and/or system that includes a computing platform that is operable to obtain, in a timely fashion, at least the information for analyzing the select-vehicle data, whereby after obtaining this information, the computing platform is not rendered useless for carrying out an analysis and/or repair of a vehicle. Such an apparatus and/or system may be advantageously configured to obtain the information for analyzing the select-vehicle data without the need for purchasing all (or even a significant subset) of the information for all vehicles, and without aforementioned problems related to obtaining such information. However, such an apparatus and/or system may benefit equally as well when configured to obtain the information for analyzing the select-vehicle data that is sold by vehicle make, model, model year, or some combination thereof.

Additionally, there is a need for a method directed to obtaining, in a timely fashion, at least the information for analyzing the select-vehicle data, whereby after obtaining this information, an analysis and/or repair of a vehicle may be carried out. This method may advantageously obtain the information for analyzing the select-vehicle data without the need for purchasing all (or even a significant subset) of the information for all vehicles, and without aforementioned problems related to obtaining such information. Such method may also advantageously obtain the information for analyzing the select-vehicle data that is sold by vehicle make, model, model year, or some combination thereof.

### SUMMARY

In general, the following relates to a system and method for providing access to or supplying particular vehicle-diagnostic information to a vehicle-diagnostic system (“VDS”) in response to a request generated by the VDS for such particular vehicle information. Disclosed herein below are a number of examples of such system, one of which includes a VDS that is capable of obtaining and interpreting vehicle-diagnostic data; a network server that communicates with the VDS; and an information-retrieval engine that is capable of searching one or more external information providers for vehicle diagnostic and operational information that the VDS lacks.

The network server includes logic to (i) receive from the VDS a first request for particular vehicle information; (ii) provide to the information-retrieval engine the first request, (iii) receive from the information-retrieval engine an indication of whether the particular vehicle information has been located; (iv) receive from the information-retrieval engine the particular vehicle information; and (v) provide to the VDS the particular vehicle information. The information-retrieval engine includes logic to (i) receive from the network server the first request for particular vehicle information; (ii) search external vehicle information providers for the particular vehicle information, and (iii) provide to the network server the particular vehicle information.

The VDS may include a diagnostic and command-and-control (“DCC”) device that may include a computing platform, and that may have the ability to update the computing platform in accordance with vehicle information provided by the network sever. Additionally, the system may further include a billing server having logic for charging and processing fees for delivering data to the user interface.

Also disclosed herein below are a number of examples of the method. In one of these examples, the method includes functions for receiving from a VDS communicatively coupled to a network server a request for particular vehicle information; searching one or more external vehicle information providers for the particular vehicle information; requesting from the VDS service-validating information to substantiate payment for the particular vehicle information; determining if the VDS has provided service-validating information; retrieving the particular vehicle information; and then providing to the VDS the particular vehicle information.

Additionally, the method may include determining a fee associated with obtaining the particular vehicle information, determining an accessibility level of the user utilizing the user interface, and determining a total cost of providing the particular vehicle information to the user. Furthermore, to facilitate the processing of fees, the method may include generating a list of payment options; presenting the list of payment options to the VDS; receiving from the VDS a request for payment; and processing the request for payment.

### BRIEF DESCRIPTION OF THE DRAWINGS

Exemplary embodiments are described below in conjunction with the appended figures, wherein like reference numerals refer to like elements in the various figures, and wherein:

FIG. 1 is a first block diagram illustrating an example of a system for providing access to or otherwise supplying vehicle diagnostic and operational information to a vehicle-diagnostic system;

FIG. 2 is a second block diagram illustrating an example of a system for providing access to or otherwise supplying vehicle diagnostic and operational information to a vehicle-diagnostic system;

FIG. 3 is a third block diagram illustrating an example of a system for providing access to or otherwise supplying to vehicle diagnostic and operational information to a vehicle-diagnostic system;

FIG. 4 is a first flow diagram illustrating an example of a process for providing to a vehicle-diagnostic system via a vehicle-information marketplace vehicle diagnostic and operational information;

FIG. 5 is a second flow diagram illustrating an example of a process for providing to a vehicle-diagnostic system via a vehicle-information marketplace vehicle diagnostic information;

FIG. 6 is a third block diagram illustrating an example of a general architecture of scan-type diagnostic tool that may be utilized as a user interface; and

FIG. 7 is an example compilation of screen shots of the display of a user interface.

### DETAILED DESCRIPTION

1. Overview

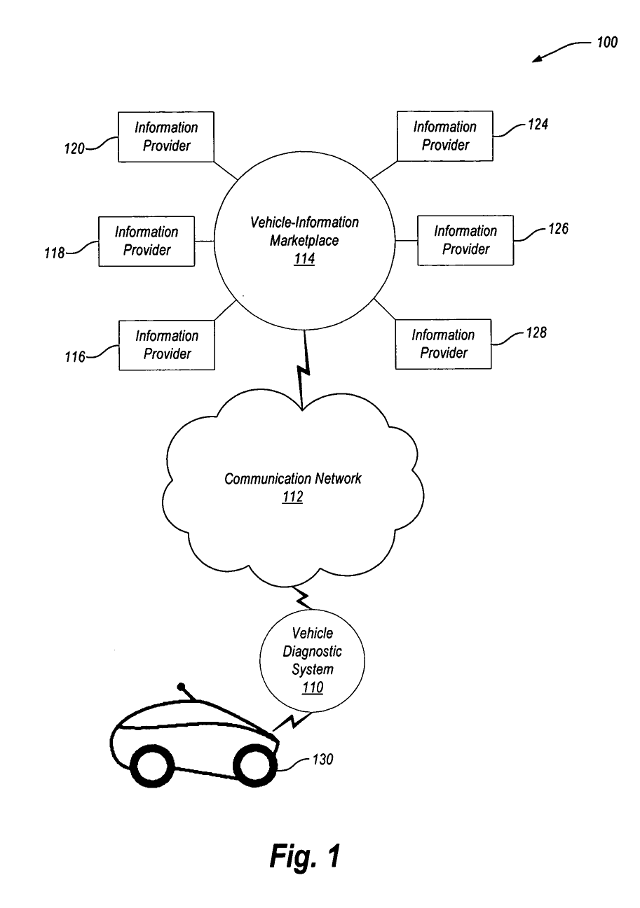

FIG. 1 is a block diagram illustrating an example of a system 100 for providing access to or otherwise supplying, in response to a request for particular vehicle information, vehicle diagnostic data to a vehicle-diagnostic system. The system includes a vehicle-information marketplace (“VIM”) 114 communicatively coupled via a communication network 112 to a vehicle-diagnostic system (“VDS”) 110.

Deployment of the system 100 may provide a user of the VDS 110 with the ability to access information related to vehicle diagnostics and repair in a manner consistent with substantial cost savings, improved workflow, and higher customer and employee satisfaction as compared to legacy processes and systems. The VIM 114 may be a single contact point for obtaining from each of the vehicle-information providers 116-128 the information related to vehicle diagnostics and repair.

Through the deployment of the VIM 114, the system 100 may beneficially provide a highly adaptable and extensible system that not only delivers enhanced diagnostics over traditional diagnostics, but also enhanced value through the integration of the VDS 110 with the VIM 114. Such integration allows the VDS 110 to obtain, on demand, from one or more vehicle-information providers 116-128 coupled to the VIM 114 information that relates to an operation; an analysis, including monitoring and/or diagnosing; and/or a repair of a vehicle 130 (hereinafter referred to as “vehicle information”). This vehicle information may include, for example, (i) content, such as parametric and/or characteristic data associated with one or more conditions of the vehicle 130, and/or (ii) at least one vehicle application, which, in turn, may include logic that employs directives or other commands that utilize such content to aid in carrying out a servicing event of the vehicle 130.

The integration may allow, for example, a virtual or seemingly transparent merging of the application for carrying out diagnosis of the vehicle 130 with one or more sources of the vehicle information. Having the vehicle information available on demand via the VIM 114, the VDS 110 can beneficially obtain, as needed, vehicle information associated with analyzing vehicle data, which may be obtained from the vehicle 130. By obtaining such vehicle information, the VDS 110 can carry out a servicing event, e.g., vehicle diagnostics, of such vehicle 130 despite not being previously configured to do so.

For example, the VDS 110 may employ a diagnostic-type vehicle application for carrying out a diagnosis of the vehicle 140. The diagnostic-type vehicle application, in general, may contain a number of functional modules for processing vehicle data that can be passed between vehicle 130 and the VDS 110. The functional modules process the vehicle data as a function of the vehicle information, which as noted may include logic, such as directives or other commands, and content, which, in turn, may include parametric and/or characteristic data.

When the VDS 110 obtains select-vehicle data associated with a particular operation of the vehicle, and then ascertains that it lacks vehicle information for analyzing the select-vehicle data, the VDS 110 is operable to obtain the vehicle information it lacks. To do this, for example, the VDS 110 may communicatively couple to the VIM 114 via the communication network 112. After coupling to the VIM 114, the VDS 110 is able to request the particular vehicle information for analyzing the select-vehicle data (hereinafter referred to as “particular vehicle information”).

The VIM 114 responds by (i) obtaining from one or more of the vehicle-information providers 116-128 the particular vehicle information, and (ii) providing the particular vehicle information to the VDS 110. After obtaining the particular vehicle information via the VIM 114, the VDS 110 may then analyze the condition of the vehicle using at least a portion of such particular vehicle information.

2. Architecture

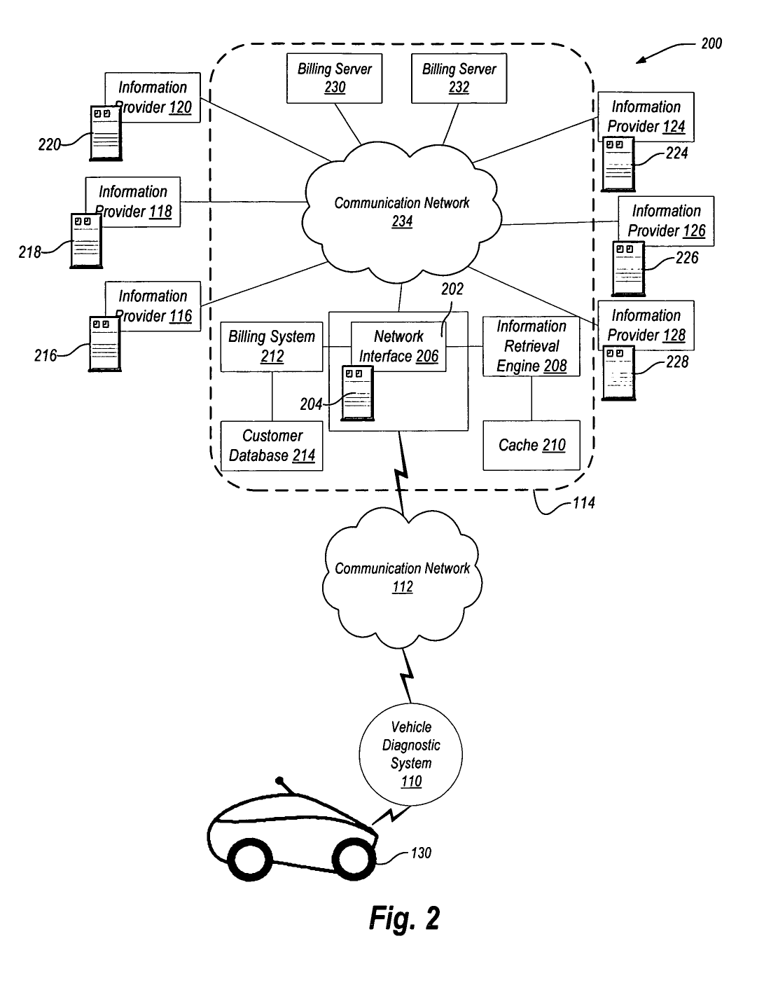

FIG. 2 is a block diagram illustrating an example of a system 200 for providing access to or otherwise supplying vehicle information to a vehicle-diagnostic system, such as VDS 110. The system 200 of FIG. 2 is similar to the system 100 of FIG. 1 in many aspects, except as described herein.

In the system 200, the VIM 114 includes an information-retrieval engine 208, a billing system 212, logic adapted to transact with one or more billing servers 230, 232 to carry out fee arrangements for charging an processing fees for obtaining the particular vehicle content, and a network server 202. The network server 202, in turn, may include a network interface 206 and a network-host platform 204.

The network server 202 may be adapted or configured (collectively “adapted”) to access the user interface 110 via a first communication network 112, and the vehicle information providers 116-128 via a second communication network 234. The VIM 114 may include the entire or less than the entire second communication network 234, as further described below.

The network interface 206 acts as an intermediary between the network-host platform 204 and the communication networks 112, 234. As the intermediary, the network interface 206 is adapted to permit the network-host platform 204 to exchange (i.e., receive and transmit) information, including the vehicle data, with the communication networks 112, 234, and in turn, between the VIM 114 and VDS 110.

To do this, the network interface 206 may generally perform modulating and demodulating functions to place the information in a form compatible with transport between the communication networks 112, 234 and the various components of the VIM 114. Additionally, the network interface 206 may also be adapted to provide the information-retrieval engine 208 and billing system 212 with access to the communication networks 112, 234.

The network interface 206 may be adapted to allow information exchange among the network-host platform 204, billing system 212, and information-retrieval engine 208 using Ethernet, Wireless Ethernet, DSL, ADSL, universal serial bus (USB), IEEE 1894, or other physical transport standards and protocols utilized by the communication networks 112, 234. Alternatively, the network-host platform 204, billing system 212, and information-retrieval engine 208 may be housed in or otherwise combined into a single computing platform. As such, the network interface 206 may be configured as a local interface. As a local interface, the network interface 206 may be adapted to provide communication among the network-host platform 204, billing system 212, and information-retrieval engine 208 without transport across the communication networks 112, 234.

The network-host platform 204 is adapted to receive requests for vehicle information from the VDS 110 via the network interface 206 and communicate with the information-retrieval engine 208 to process these requests. The network-host platform 204 in conjunction with the billing system 212 is adapted to process service-validating information, as described in more detail below.

In order to gain access to or obtain the particular vehicle information, the VDS 110 may generate and send to the network interface 206 via the first communication network 112 a request for the particular vehicle information (vehicle-information request). After receipt at the network interface 206, the VIM 114, in turn, may process this vehicle-information request as a fuiction of various factors, including any of a plurality of capabilities and/or format of the VDS 110.

If, for example, the vehicle-information request is directed towards an updated version of an application currently stored on the VDS 110, then the network-host platform 204 may interrogate the VDS 110 for the version of the currently stored application. The network-host platform 204 may then modify the vehicle-information request for vehicle information such that it applies to the availability of more recent versions of the application.

To aid in carrying out these functions, the network-host platform 204 may include hardware-based, software-based, and/or firmware-based logic. This logic may be embodied, for example, in a processing unit and a memory. The memory may contain computing instructions, which are executable by the processing unit for carrying out the above-noted functions.

These instructions may provide the processing unit with the ability to establish communication with the VDS 110, receive from the VDS 110 the vehicle-information request, and interrogate the VDS 110 for additional information regarding the particular vehicle information. In addition, the instructions may provide the processing unit with the ability to parse the vehicle-information request and additional information regarding the particular vehicle information into retrieval criteria, and provide to the information-retrieval engine 208 this retrieval criteria.

In addition, the memory of the network-host platform 204 may include computing instructions that provide the processing unit with the ability to receive the particular vehicle information from the information-retrieval engine 208. The memory of the network-host platform 204 may include both instructions for formatting the particular vehicle information so that it may be properly received and interpreted by the VDS 110, and providing to the VDS 110 the particular vehicle information, as formatted.

As described above, the network-host platform 204 may format the particular vehicle information so that it can be properly received and utilized by the VDS 110. For example, the VDS 110 may provide to the network-host platform 204 information related to the graphical and processing capabilities of the VDS 110. The network-host platform 204 may then format any data sent to the VDS 110 so as not to exceed these processing capabilities.

If, for example, the VDS 110 is incapable of displaying certain images (such as images encoded with JPEG, GIF, and like standards) or processing certain types of document files (such as Microsoft Word documents, Adobe Acrobat documents, and the like), the network-host platform 204 may restrict from being sent to VDS 110 such images and document files. Alternatively, the network-host platform 204 may reformat files incapable of being displayed so that they may be in a form suitable for use by the VDS 110.

The information-retrieval engine 208 may have the ability to access the vehicle information providers 116-128 through the second communication network 234 via a gateway function provided by the network interface 206. The information-retrieval engine 208 may also include logic for generating or forwarding the vehicle-information request, sending to the vehicle information providers 116-128 the vehicle-information request, and receiving from the vehicle information providers 116-128 the particular vehicle information. The information-retrieval engine 208 may also include logic for receiving from the network-host platform 204 the vehicle-information request and additional information regarding the particular vehicle information sent by the VDS 110.

The information-retrieval engine may include logic for storing in the cache 210 the particular vehicle information received from the vehicle information providers 116-128. Alternatively, the particular vehicle information may be passed to the network-host platform 204 without being stored in the cache 210.

The types of particular vehicle information that may be stored and retrieved by the information-retrieval engine 208 may include vehicle diagnostic applications, vehicle diagnostic code descriptions, digital content describing vehicle components, digital content describing vehicle diagnostic information, and the like. Associated data corresponding to the particular vehicle information may also be stored along with the particular vehicle information. This associated data may include such information as a virtual address of the relevant vehicle information, and/or an indicator of the type of vehicle information, such as the file extension or application type. The information-retrieval engine 208 is further adapted to provide the particular vehicle information to the VDS 110 after retrieval of such information.

If, however, the VIM 114 is adapted to support the administering and processing of fees, then the VDS 110 may be further adapted to receive from the information-retrieval engine 208 a list of fee-payment options prior to receiving the particular vehicle information. These fee-payment options may be based upon user information provided from the VDS 110. The user information may include data associated with an established user account. The established user account, in turn, defines a level of access that a user has with respect to the particular vehicle information located by the information-retrieval engine 208.

By way of an example, the user account may include an indication that the user has free access to the particular vehicle information accessed from or supplied by a first information provider, but does not have free access to the particular vehicle information accessed from or supplied by other information providers. In this scenario, the particular vehicle information retrieved from the first vehicle information provider may be sent to the VDS 110 without any additional cost. But the particular vehicle information retrieved from the other information providers may require the network-host platform 206, in conjunction with the billing system 212, to charge the user for accessing this data.

Each of the vehicle information providers 116-118 includes a corresponding vehicle information server, namely, vehicle-information servers 216-228, for providing the vehicle information to the VDS 110. The vehicle-information servers 216-228 may employ software that operates upon a processing system, e.g., a general purpose computing platform, a specialized computing platform, an open source, e.g., a Linux, computing platform, a proprietary computing platform, and the like. This software may provide a host of applications including one or more applications for (i) providing, in response to the vehicle-information request, the particular vehicle information to the VDS (ii) requesting the particular vehicle information, and (iii) providing the service-validating information, if any.

By way of example, each of the vehicle-information servers 216-228 may be a WindowsXP-based server equipped with a SQL Server 2000 database management system (DBMS), and business logic for servicing the VDS 110, such as front-office applications and back-office applications,. The front-office applications and the back-office applications may include, for example, Customer Relationship Management (CRM), Sales Force Automation (SFA), Enterprise Resource Planning (ERP) and/or other customer service and support applications.

CRM allows the VIM 114 and/or each of the vehicle-information servers 216-228 to operate as an integrated information system for controlling presales and postsales activities. SFA provides such functions as contact management and product configurators. ERP provides such functions as order entry, accounts receivable and payable, general ledger, and contract management. The CRM, SFA and ERP provide a business platform that enables the VIM 114 and/or each of the vehicle-information servers 216-228 to interact with the VDS 110 through the communication networks 112, 234.

Through this business platform, the VIM 114 and/or each of the vehicle-information servers 216-228 can ensure that any charge for the vehicle information is covered or otherwise paid for. The charge for the vehicle information may be a monetary fee, which can be covered by one or more fee arrangements. These fee arrangements may include a subscription-fee arrangement, one-time-fee arrangement, one-time-activation-fee arrangement, prepaid-fee arrangement, renewal-fee arrangement, etc. The fee arrangements may be based on usage. For example, the fee arrangement may be based upon (i) the particular vehicle information accessed, (ii) the number of times that the user accesses the particular information, (iii) the quantity of the particular information accessed by the user, (iv) etc. Many other fee arrangements are possible as well.

To ensure that any charge for the vehicle information is covered, the VIM 114 and/or each of the vehicle-information servers 216-228 may be configured to receive from the VDS 110 the service-validating information to substantiate that the VDS 110 has paid or is operable to pay for the vehicle information. Such service-validating information may include, for example, subscription information, credit information, prepaid-fee-arrangement information, debit information, checking account information, savings account information; and/or any other information to substantiate that the VDS has paid or is operable to pay for the vehicle information. To facilitate this, the billing system 212 may include logic for receiving the service-validating information from the VDS 110, and providing the service-validating information to the vehicle-information servers 216-228, or to other billing servers 230-232.

To facilitate integration with the VIM 114, the VDS 110 may also include logic for carrying out communications directly with one or more of the vehicle-information servers 216-228 for obtaining the vehicle information. This logic may also be configured to exchange with one or more of the vehicle-information servers 216-228 the select vehicle data and/or the service-validating information, which is used by vehicle-information providers 216-228 to determine whether to supply the particular vehicle information to the VDS 110.

Although the network server 204 and each of the vehicle-information servers 216-228 are described above as a single computing platform, the network server 204 and each of the vehicle-information servers 216-228 may include a series of servers that provide applications for serving the particular vehicle information to the VDS 110. These servers may carry out web page hosting, business logic applications, data storage, communications network management, etc.

Each of the communication networks 112, 234 may be a partial or full deployment of most any communication or computer network, and thus, can include a few or many network elements, most of which are not shown. The format of these communication networks may be public or private, terrestrial wireless or satellite, and/or wireline, and may take into account any communication protocols for facilitating communications between the devices.

Public wired and/or wireless networks typically provide telecommunications and other networking services in a particular geographic coverage area to its subscribers. And generally, any interested member of the public meeting minimal criteria may become a subscriber of public network. In the case of terrestrial wireless or satellite networks, public networks typically provide coverage to other wireless networks' subscribers who are roaming within the coverage area of network as well.

Additionally, the coverage area of public network is typically wide-ranging. For example, the coverage area of a wireless public network may encompass a metropolitan area, a substantial part of a metropolitan area, numerous metropolitan areas, or an entire nation or region. When integrated with public wired and satellite networks, the combined networks provide national along with international coverage. Thus, both of the communication networks 112, 234 may include portions of a Public Switch Telephone Network (PSTN), the Internet, core and proprietary public networks, other wired voice and packet-data networks, and/or wireless voice and packet-data networks, such as, 1G-4G public networks, Bluetooth™ wireless networks, IEEE 802.11 et, seq. wireless local area networks (WLANs), UltraWideBand (UWB) wireless networks, ZigBee wireless personal area networks (WPANs), IEEE 802.15 WPANs, IEEE 802.16 broadband wireless access (BWA) networks (a.k.a. “WiMAX”) telecommunication networks. Accordingly, both of the communication networks 112, 234 may include circuit-switched as well as packet-data elements to provide transport between (i) the vehicle systems and the VDS 110, and (ii) the VDS 110 and one or more of the vehicle-information servers 216-228.

Alternatively, both of the communication networks 112, 234 may be a private or “enterprise” wired or wireless network. Unlike public networks, private networks advantageously provide the enterprise with greater control over the network, which in turn allows vast customization of the services provided to the network's users and/or subscribers.

These networks are “private” in that the networks' coverage areas are more geographically limited. Typically, but not necessarily, subscription to such private networks is limited to a select group of subscribers. Networks deployed by many enterprises that only allow their employees, customers, vendors, and suppliers to subscribe exemplify these private networks.

Many enterprises, service facilities, Small Office/Home Office (SOHO) entities, and private individuals have private-wireline-switching systems. These private-wireline-switching systems may include, for example, private branch exchanges (PBXs) and/or media gateways. The private-wireline-switching systems switch, couple or otherwise connect communications (i) internally, i.e., among the subscribers of the network and (ii) externally, i.e., between the subscribers of the private network and subscribers of public networks.

In addition to the wireline networks, enterprises, service facilities, SOHOs and private individuals are increasingly deploying private wireless communication systems, such as wireless office telephone systems (“WOTS”); Bluetooth™, IEEE 802.11, or other WLANs; IEEE 802.15, Zigbee, UWB or other WPANs; and/or IEEE 802.16 or other BWA networks, in lieu of or in addition to wireline switching systems. Similar to public networks, private networks may be integral to or integrated with other private and public satellite, terrestrial wireless, and wireline networks to provide national and international coverage. It is recognized, however, that differences between private and public networks may only be a matter of semantics due to convergence between communication technologies.

Accordingly, both of the communication networks 112, 232 can be any of a private and/or public terrestrial, satellite and/or other wireless network. And both the communication networks 112, 232 can be incorporated into (i) a wide-area network (WAN), thereby creating a Wireless WAN (WWAN); (ii) a wired local area network (LAN), thereby creating a WLAN, WPAN, UWB network or BWA network; and/or (iii) other wired network. Alternatively, each of wireless communication networks can be a standalone WLAN, WLAN, WPAN, UWB network or BWA network.

At times, a single wireless service or technology may not provide a desirable messaging cost structure or geographical coverage to support all the features and users of the system 200. Multiple services might be used instead to provide for dynamic balancing between messaging costs and message timeliness. In addition, different wireless services and technologies may have different application program interfaces (APIs) and/or require custom interfaces for given computing environments.

Moreover, messaging capabilities may differ across different services and technologies. To take advantage of such benefits, the VDS 110 and the vehicle-information servers 216-228 may include multiple interface adapters for accessing the multiple formats of the and the communication networks 112, 234.

In addition, both of the communication networks 112, 232 may include an access node, such as a wireless-access point (not shown) or other network adapter, to provide network access (e.g., ingress and egress) to the VDS 110 and the vehicle-information servers 216-228. Each of the access nodes (or other network adapters) may therefore act as a gateway between the VDS 110 and the vehicle-information servers 216-228.

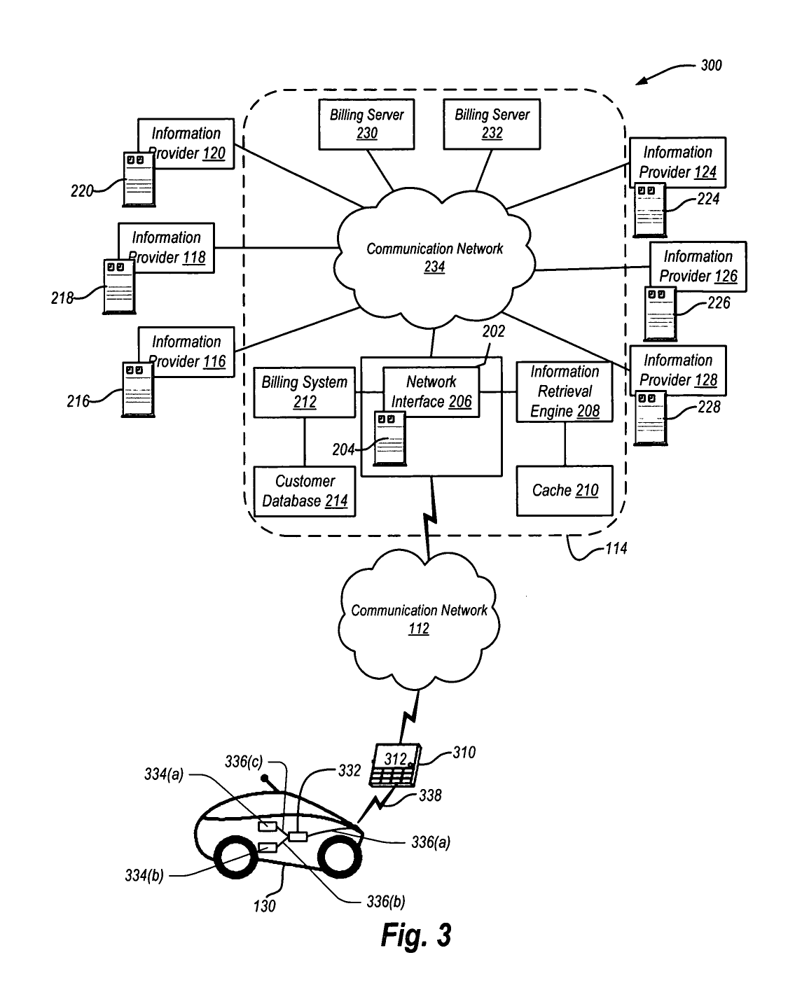

FIG. 3 is a block diagram illustrating an example of a system 300.for providing access to or otherwise supplying vehicle information to a vehicle-diagnostic system, such as VDS 110. The system 300 of FIG. 3 is similar to the system 200 of FIG. 2 in many aspects, except as described herein.

In the system 300, the VDS 110 is embodied as a DCC device 310. As shown, the DCC device 310 is communicatively coupled to an on-board diagnostic (OBD) device 332 and one or more vehicle systems 334(a)-334(b) of the vehicle 130 via one or more internal-communication links 336(a)-336(c) and a vehicle-communication link or network (“vehicle-communication link”) 338.

The OBD device 332 may act as a gateway for supplying to the DCC device 310 vehicle data generated by one or more of the vehicle systems 334(a)-334(b). The DCC device 310, however, may obtain the vehicle data generated by the vehicle systems 334(a)-334(c) from the vehicle-communication link and/or internal-communication links 338, 336(a)-336(c) without the use of the OBD device 332.

The DCC device 310 may be embodied as computing platform that is distributed among a plurality of nodes or, alternatively, concentrated on a single node. All or portions of the DCC device 310 may be temporarily coupled or, alternatively, affixed to the vehicle 130.

Although not shown, the DCC device 310 may include or be coupled to a wired or wireless vehicle adapter for adapting it to the particular (e.g., manufacturer, make, and/or model of the) vehicle 130. The vehicle adapter may contain hardware and software for coupling the DCC device 310 to the internal-communication links 336(a)-336(c) to which the OBD device 332 and vehicle systems 334(a)-334(b) may be coupled.

This vehicle adapter may include, for example, an industry standard serial data module, or variant thereof, for vehicle buses based upon Society of Automotive Engineering standards, such SAE J1708, SAE J1939, ISO 9141, J1850, Keyword Protocol (“KWP”) 2000, Controller Area Network (“CAN”), CAN-II, and/or other automotive, small-engine, marine and heavy-duty application standards. For existing applications, future high-speed-bus applications, and applications with other interfaces, an Automotive Serial Data Module (ASDM) or variant thereof may be used.

Being a computing system or device, the DCC device 310 may include software operating on a processing system for carrying out the vehicle application and the functions thereof. The processing system may be, for example, a general-purpose computing platform, a specialized computing platform, an open source (e.g., a Linux), computing platform, a proprietary computing platform, and the like.

The vehicle application may be maintained in memory of the DCC device 310, and thus, may be concentrated on a single node or distributed, in whole or in part, among one or more of the plurality of nodes. When needed, the DCC device 310 may obtain the vehicle application from the single node or the plurality of nodes.

As noted, the vehicle application may include logic, such as software and/or firmware code that employs directives or other commands that utilize the aforementioned content for processing the select-vehicle data. The vehicle application may be assigned a version number to denote that it may include a specific set of the logic that uses one or more specific sets of the content. Similarly, the content may be assigned a version number to denote that it may include a specific set of the content. As described in more detail below, these version numbers may be used by the DCC device 310 and/or the VIM 114 to determine whether the vehicle application and/or content possess or, alternately, lack the particular vehicle information for analyzing the select-vehicle data.

Also included in the vehicle application is logic that directs the DCC device 310 to interrogate the vehicle systems 334(a)-334(b) so as to obtain the select-vehicle data, which may include diagnostic, characteristic and/or status information. The diagnostic, characteristic and/or status information, in turn, may be provided as standardized or proprietary vehicle diagnostic, status and error codes.

To allow the vehicle application to carry out this interrogation and transfer the select-vehicle data, the DCC device 310 and/or the vehicle application may include logic for effectuating (e.g., establishing, maintaining and tearing down) communications between the DCC device 310, the OBD device 332, and the vehicle systems 334(a)-334(b). Such communications and vehicle diagnostic information transfer may occur over the internal-communication links 336(a)-336(b) and the vehicle-communication link 338.

As noted above, the select vehicle data may be used by the vehicle application to aid in analyzing a condition of the vehicle 130, including, for example, the diagnosis and resolution of a problem or other servicing event. The select vehicle data along with resolution and vehicle diagnosis information may be supplied, via a user interface 312, to a user of the DCC device 310, such as a vehicle-maintenance technician, other person and/or machine (collectively referred to hereinafter as “user”).

The user interface 312 may be optionally arranged with components, such as a data entry device (e.g., a keyboard or keypad), a display and graphical-user-interface (GUI) environment. Such components may be operable to enhance the vehicle applications by providing (i) simultaneous display of vehicle data and other information; (ii) user-friendly access to features of the DCC device 310; (iii) streamlined data entry; and/or (iv) a graphical display of parameters (e.g., history, meters, bar graphs, etc.).

The user interface 312 of the DCC device 310 may also be adapted to interact with the user, a barcode and/or other-type scanner to obtain vehicle details for logging the vehicle 130 in to the DCC device 310. These vehicle details may include, for example, a make, model, year and/or vehicle identification number of the vehicle 130. The DCC device 310, however, may be configured to obtain the vehicle details from the vehicle data so as to obviate a physical identification.

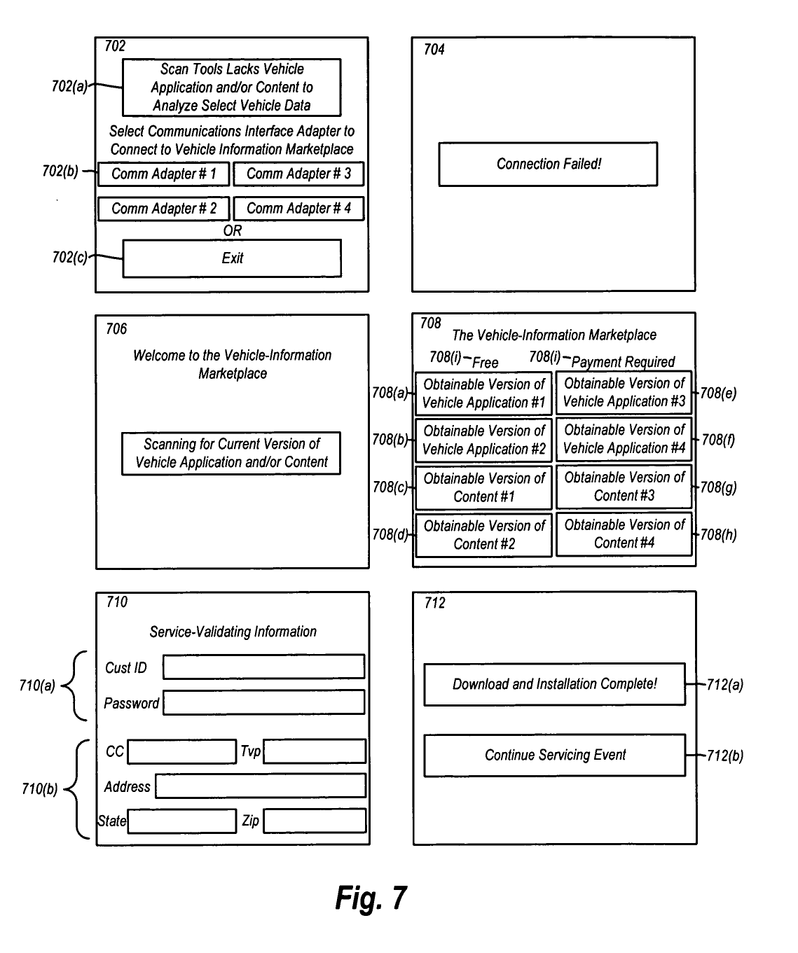

In one embodiment, the DCC device 310 may be deployed as a handheld device, such as a pocket personal computer; personal digital assistant; a mobile telephone; a scan-type diagnostic tool, such as a scan-type tool 700 described herein below and illustrated in FIG. 7; etc., which may be removably or wirelessly connected to the vehicle 130. Alternatively, the DCC device 310 may be embodied as a ruggedized handheld computer, such as a Symbol 1740, which runs a Palm operating system, or a Symbol 2840, which runs a Windows CE operating system.

Such ruggedized handheld computer or any other embodiment of the DCC device 310 may be equipped with one or more of communications interface adapters. These communications interface adapters may be adapted to, in accordance with an appropriate communication protocol, (i) communicate with the vehicle systems 334(a)-334(b) via the internal-communication links 336(a)-336(c) and vehicle-communication link 338, and (ii) communicate with one or more of the vehicle-information servers 316-328 via the communication networks 112, 234 and the VMS 114.

If the DCC device 310 is configured in distributed fashion across the plurality of nodes, then the nodes of DCC device may 310 may include one or more interface adapters for communicating among such nodes. These interface adapters may be adapted to allow the nodes to communicate over internal system busses of the computing platform, an Ethernet connection, a universal serial bus, an IEEE 1894 connection, and/or any other local and networking protocol connection. Using the interface adapters, the node or nodes of the DCC device 310 that carry out the vehicle application (“vehicle-application processing nodes”) may obtain the vehicle application from other nodes, as needed, rather than keeping resident all the vehicle applications.

By way of example, one of the vehicle-application processing nodes of the DCC device 310 may be a handheld module that can be configured to carry out one or more of the vehicle applications. Instead of maintaining all the vehicle applications in the handheld module, however, the handheld module may only maintain a subset of the vehicle applications to take advantage of low cost, low power and flexibility of handheld-type devices. In such case, the handheld module may obtain from other, e.g., storage and/or docking, nodes of the DCC device 310 one or more of the vehicle applications that are not locally maintained in the handheld module.

Alternatively, the handheld module may maintain all the vehicle applications locally. In any case, new vehicle applications can be added to the vehicle-application processing nodes of the DCC device 310 on an as needed basis.

In another embodiment, the DCC device 310 may be deployed as a client/server or peer-to-peer system. Recognizing that each device in client/server and peer-to-peer systems can be both a requestor and a supplier, each of the client, server and/or peers are referred to herein simply as a system node. In either the client/server or peer-to-peer system, for example, a first system node may be positioned aboard the vehicle 130 to obtain vehicle data from the vehicle systems 334(a)-334(b). To do this, the first system node may be adapted to communicatively couple to the vehicle systems 334(a)-334(b) via the internal-communication links 336(a)-336(c).

The first system node may be further adapted to communicatively couple to a second system node via the vehicle-communication link 338. This way the vehicle data may be passed between the vehicle systems 334(a)-334(b) and the rest of the system nodes via the first and second system nodes.

The above-described architectures of the systems 100, 200, and 300 are for exemplary purposes only. Other embodiments and/or more or less components of each of the systems 100, 200, 300 may be used as well.

3. Method

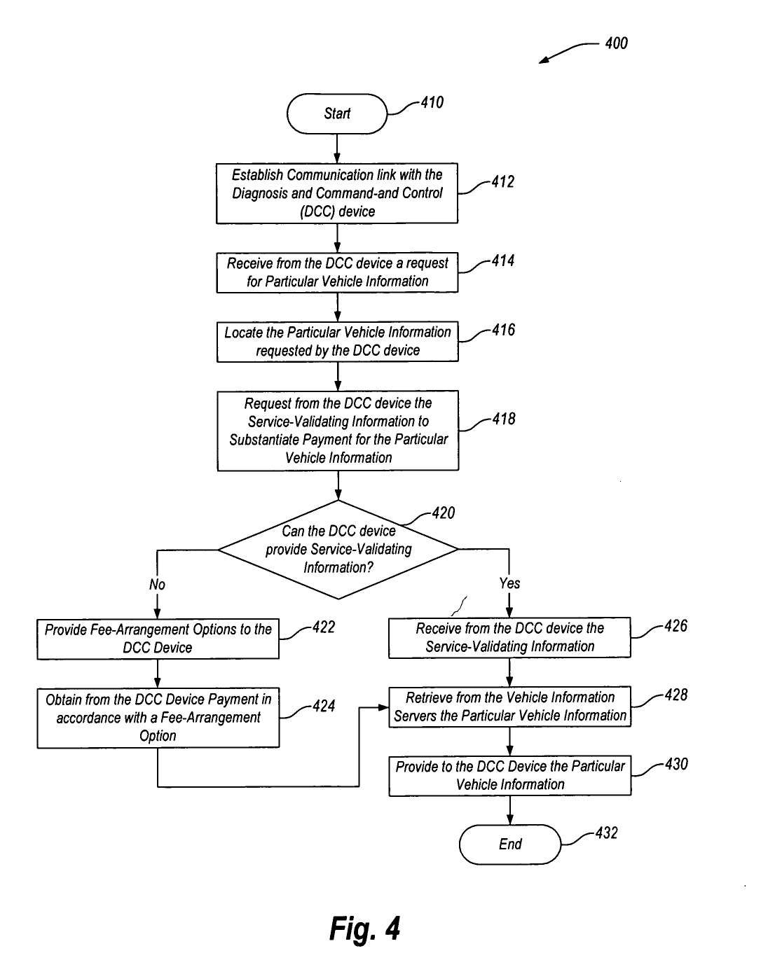

FIG. 4 is a flow diagram illustrating an example flow 400 for receiving and fulfilling a request for particular vehicle information. Although the flow 400 may be carried out by different architectures, the following is described with reference to the system 300 for simplicity.

In this embodiment, the DCC device 310 may be embodied as any of the handheld systems noted above. The VIM 114 may be configured as any of the system embodiments noted above. The communication networks 112 and 234 may each be embodied as a WLAN integrated with a public network, such as the Internet. The user of the DCC device 310 may be a service technician.

The flow 400 starts at block 410. Before the start of the flow 400, however, the service technician may utilize the DCC device 310 to interrogate the OBD device 332 and retrieve the select-vehicle data. Later, either the service technician or the DCC device 310 may determine that the DCC device 310 lacks particular vehicle information for analyzing the select-vehicle data.

Thereafter, the DCC device 310 may seek to establish a communication link with the VIM 114, as shown in block 412. To accomplish this, the DCC device 310 via one or more of its communication adapters may establish a point-to-point conduit with the network server 204 via communication network 112 and the network interface 206. The point-to-point conduit may be effectuated by the DCC device 310 first registering with the communication network 112, and then coupling with the network server 204 via the communication network 112 and the network interface 206. The network server 204 may have previously registered with the communication networks 112 and 234.

Registering with the communication networks 112 and 234, in the simplest form, may include merely “associating” the network server 204 with the communication network 112 and 234 via their respective wireless access points. Registering may also include “logging” into the communication networks 112 and 234, which may include providing a username and password. Registering with the communication networks 112 and 234 may also include employing secure connection services, such as IEEE 802.11 Wired Equivalency Protocol (WEP), security system identification (SSID), extensible authentication protocol (EAP), Internet Protocol Security (IPSEC), or other secure connection service.

Details of registering the DCC device 310 in a Bluetooth™, IEEE 802.11, or other WLAN; and IEEE 802.15, Zigbee, UWB or other WPAN; and/or IEEE 802.16 or other BWA network are generally described in a protocol associated with the format of such networks. For instance, the details for registering in an IEEE 802.11 WLAN, IEEE IEEE 802.15 WPAN, IEEE 802.16 BWA network or Bluetooth WLAN are described in more detail in the respective IEEE 802.11 protocol, IEEE 802.15 protocol, IEEE 802.16 protocol and Bluetooth standard, each of which is incorporated herein by reference in its entirety.

After registering, the network server 204 may await an attempt by the DCC device 310 to establish, using generally known techniques, the point-to-point conduit with the network server 204. After the point-to-point conduit is established, the network server 204 may then receive from the DCC device 310 the vehicle-information request, as shown in block 414.

The vehicle-information request may be formatted in accordance with most any communication signaling and/or messaging protocol. For example, the vehicle-information request may be formatted according to one or more protocols for communicating via the Internet, such as HTML, XML, VRML, FTP, SMTP, SIP, and the like.

Responsive to the vehicle-information request, the VIM 114 may attempt to locate the particular vehicle information, as shown in block 416. The network server 204 may forward the vehicle-information request to the information-retrieval engine 208. The information-retrieval engine 208 may then examine the cache 210 to determine if the particular vehicle information has already been retrieved from one of the vehicle information providers 220-228.

If the particular vehicle information is not in the cache 210, the information-retrieval engine 208 may query the vehicle information providers 216-228 for the particular vehicle information. Each of the vehicle information providers 216-228 may respond with an indication as to whether the particular vehicle information provider has access to the particular vehicle information. The information-retrieval engine 208 then stores the location(s) from which it may later retrieve the particular vehicle information, if necessary.

Later, the information-retrieval engine 208 indicates to the network server 204 whether the particular vehicle information has been located. If the information-retrieval engine 208 indicates that the particular vehicle information could not be located, the network server 204 notifies the DCC device 310 as such.

However, if the information-retrieval engine 208 indicates that the particular vehicle information was successfully located, the network server 204 may send to the DCC device 310 a request for the service-validating information to substantiate that the DCC device 310 has paid for the vehicle information (“service-validating request”), as shown in block 418.

Like the vehicle-information request, the service-validating request may be formatted in accordance with most any communication signaling and/or messaging protocol. For simplicity, however, this service-validating request may be in the same format as the request form the DCC device 310.

If, the DCC device 310 cannot substantiate that it has paid for the vehicle information, the network server 204 may provide to the DCC device 310 a set of fee-arrangement options, as shown in block 422. The set of fee-arrangements may include any of the fee arrangements noted above. Through the DCC device 310, the service technician may elect one or more of the provided fee arrangements and provide to the network server 204 information to complete the elected fee arrangement(s), as shown in block 424. The network server may forward the information to complete the fee arrangement to the billing system 212, which may in turn coordinate with the billing servers 230-232 to process the fee arrangement.

After either the fee arrangement has been processed or the DCC device 310 has provided service-validating information, the information-retrieval engine 208 may retrieve from the cache 210 or the vehicle information providers 216-228 the particular vehicle information. The information-retrieval engine may then provide to the DCC device 310 the particular vehicle information via the point-to-point protocol conduit, as shown in block 430. At block 432, the flow 400 ends.

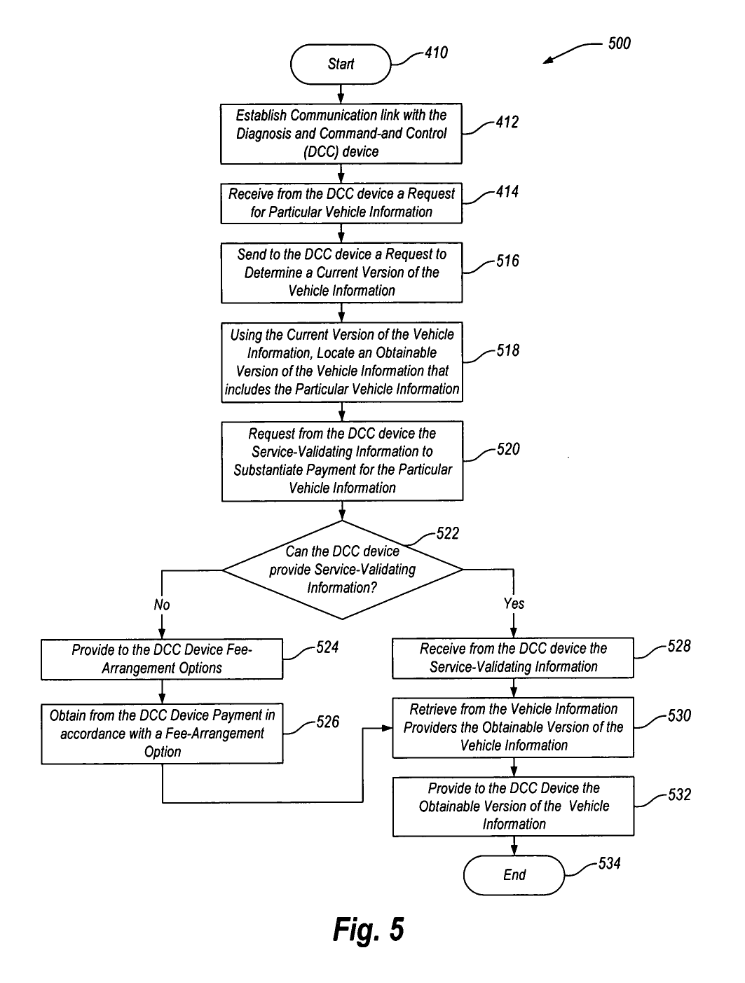

FIG. 5 shows a flow diagram illustrating a flow 500 for receiving and fulfilling a request for particular vehicle information. Although the flow 500 may be carried out by different architectures, the following is described with reference to the system 300 for simplicity. The flow 500 is similar to the flow 400 in many respects. Accordingly, many details described with respect to flow 400 are not repeated below.

Referring to block 516, the network server 204 sends to the DCC device 310 an interrogation request to interrogate the DCC device 310 to determine a version of the vehicle information possessed by the DCC device 310 (hereinafter referred to as a “current version of the vehicle information”). The interrogation request may include, for example, a request to interrogate the DCC device 310 for a current version number of the vehicle application and/or content.

The interrogation request may be formatted in accordance with most any communication signaling and/or messaging protocol. For simplicity, however, this interrogation request may be in the same format as the first request from the DCC device 310 (block 414).

Responsive to an affirmative reply to the interrogation request, the server 204 may interrogate the DCC device 310 to determine the current version of the vehicle information. In one embodiment, the network server 204 may send to the vehicle application that is residing in memory a message to (i) request the current version number of such vehicle application along with (ii) request the current version number of the content. Responsive to this message, the vehicle application may send to the network server 204 a reply message indicating its current version number along with the current version number of the content.

Alternatively, the network server 204 may send to the DCC device 310 a message to (i) request the current version number of such vehicle application along with (iii) request the current version number of the content. Responsive to this message, the DCC device 310 may scan the data store and/or memory of the DCC device 310 to obtain the current version numbers for the vehicle application and the content. After obtaining the current version numbers of the vehicle application and/or content, the DCC device 310 may send to the network server 204 a reply message that includes the current version numbers of the vehicle application and/or content.

As another alternative, the network server 204 may (i) download to the DCC device 310 (usually after approval from the DCC device 310) a query application to scan the data store and/or memory of the DCC device 310 to obtain the current version numbers for the vehicle application and/or content, and (ii) cause the DCC device 310 to execute the downloaded query application. After scanning the data store and/or memory of the DCC device 310, the query application may then send to the network server 204 the current version numbers for the vehicle application and/or content. The query application then completes, unloads from the memory of the DCC device, and is typically deleted from the DCC device 310. The query program, however, may be stored in the data store of the DCC device 210 for later retrieval and use.

Having obtained from the DCC device 310 the current version numbers of the vehicle application and/or content, the VIM 114 may attempt to locate obtainable versions of the vehicle application and/or content that include the particular vehicle information, as shown in block 518. The network server 204 may direct the information-retrieval engine 208 to attempt to locate the obtainable versions of the vehicle application and/or content.

In response, the information-retrieval engine 208 may then examine the cache 210 to determine if the obtainable versions of the vehicle application and/or content have already been retrieved from one of the vehicle information providers 220-228. If the obtainable versions of the vehicle application and/or content are not in the cache 210, the information-retrieval engine 208 may query the vehicle information providers 216-228 for the obtainable versions of the vehicle application and/or content. Each of the vehicle information providers 216-228 may respond with an indication as to whether the particular vehicle information provider has access to or can otherwise obtain the obtainable versions of the vehicle application and/or content. The information-retrieval engine 208 then stores the location(s) from which it may later retrieve the obtainable versions of the vehicle application and/or content, if necessary.

Later, the information-retrieval engine 208 indicates to the network server 204 whether the obtainable versions of the vehicle application and/or content have been located. If the information-retrieval engine 208 indicates that the obtainable versions of the vehicle application and/or content could not be located, the network server 204 notifies the DCC device 310 to this effect.

However, if the information-retrieval engine 208 indicates that the obtainable versions of the vehicle application and/or content were successfully located, the network server 204 may send to the DCC device 310 the service-validating request, as shown in block 520.

If, the DCC device 310 cannot substantiate that it has paid for the vehicle information, the network server 204 may provide to the DCC device 310 a set of fee-arrangement options, as shown in block 524. The set of fee-arrangements may include any of the fee arrangements noted above. Through the DCC device 310, the service technician may elect one or more of the provided fee arrangements and provide to the network server 204 information to complete the elected fee arrangement(s), as shown in block 526. The network server may forward the information to complete the fee arrangement to the billing system 212, which may in turn coordinate with the billing servers 230-232 to process the fee arrangement.

After either the fee arrangement has been processed or the DCC device 310 has provided service-validating information, the information-retrieval engine 208 may retrieve from the cache 210 or the vehicle information providers 216-228 the obtainable versions of the vehicle application and/or content, as shown in block 530. The information-retrieval engine may then provide to the DCC device 310 the obtainable versions of the vehicle application and/or content via the point-to-point protocol conduit, as shown in block 532. At block 534, the flow 500 ends.

The DCC device 310, after obtaining the particular vehicle information from the server 204, may carry out the servicing event using at least a portion of the particular vehicle information obtained from server 310. To do this, the DCC device 310 may, as appropriate, incorporate into (e.g., by replacement and/or modification of) its current logic and/or content any of the logic and/or content obtained from the network server 204.

The DCC device 310 may communicatively re-couple, if decoupled, to the port on the internal-communication links 336(a)-336(c) and the vehicle-communication link 338. Thereafter, the DCC device 310 may interrogate the OBD device 332 and vehicle systems 334(a)-334(b) to obtain the select-vehicle data. The DCC device 310 may then analyze one or more conditions of the vehicle 130 as a function of the select-vehicle data and at least a portion of the particular vehicle information obtained from the server 204. In turn, the DCC device 310 may send a result of the analysis to the user interface 312 for display.

4. An Exemplary Architecture of a Diagnostic and Command-and Control Device

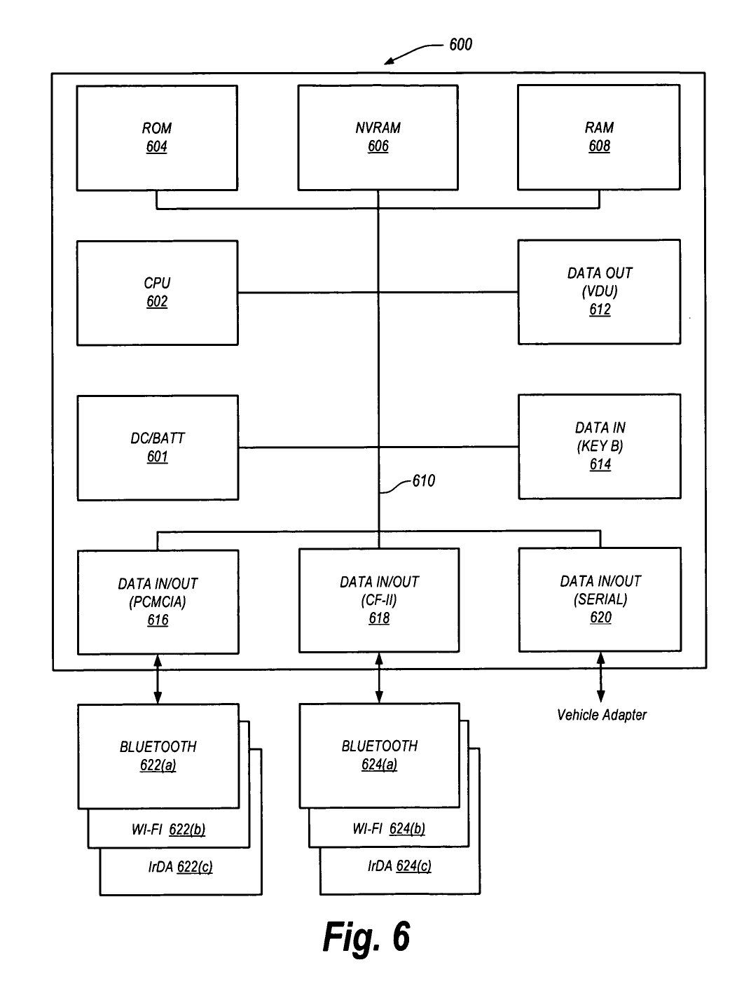

FIG. 6 is block diagram illustrating an example of a general architecture of scan-type diagnostic tool (“scan tool”) 600 for interfacing with a vehicle, such as the vehicle 130. The scan tool 600 may include a battery 601 for supplying the scan tool 600 with power, and a processor 602 that is communicatively coupled via an internal bus 610 to (i) memories 604-608; (ii) user-interface input and/or output (I/O) modules 612, 614 for an integrated user interface (not shown); and (iii) input and output (I/O) communication ports 616-620. Each of the I/O communication ports 616-620, in turn, may be respectively coupled to communications interface adapters 622(a)-622(c), communications interface adapters 624(a)-624(c), and a vehicle adapter for coupling to the OBD device 322 and one or more vehicle systems 324(a)-324(c) of vehicle 320.

The battery 601 may be a rechargeable and replaceable battery that may temporarily-connected, or alternatively, affixed to the scan tool 601. The battery 601 may provide power to each of the above-listed components connected to the internal bus 610, if necessary. The battery may also supply power to the communications interface adapters 622(a)-622(c), and 624(a)-624(c).

The processor 602 may be any processor capable of running any of the vehicle applications, as noted above. One such processor may be a processor designed for mobility, such as an Intel Mobile Centrino™ Processor. The processor 602 provides task coordination and processing functionality for carrying out the vehicle application, which includes logic (such as software and/or firmware code) that employs directives or other commands to process the select-vehicle data. This logic along with other logic for operating the scan tool 602 may be stored in the read-only memory (“ROM”) 604, non-volatile random access memory (“NVRAM”) 606, random access memory (“RAM”) 606 or a combination thereof.

For example, an operating system and device drivers for (i) the user-interface I/O modules 612, 614, (ii) the I/O communication ports 616-620, and (iii) the vehicle adapter may be stored in the ROM 604. The vehicle application, vehicle data, and device drivers for the communications interface adapters 622(a)-622(c), 624(a)-624(c) may be stored in the NVRAM 606. The RAM 608 facilitates storage for runtime processing. Accordingly, the RAM 608 may obtain after initialization some or all of the items stored in ROM 604 and NVRAM 606 along with (i) the select-vehicle data obtained via the I/O communication ports 616-620, (ii) user input obtained by the user-interface I/O modules 612, 614 via the user interface, and/or (iii) the particular vehicle information obtained from the VIM 114 via one or more of the communications interface adapters 622(a)-622(c), 624(a)-624(c).

The user-interface I/O modules 612, 614 may be adapted to provide a display and graphical-user-interface (GUI) environment. Such components may be operable to enhance the vehicle application by providing (i) simultaneous display of vehicle data and other information; (ii) user-friendly access to features of the DCC device 310; (iii) streamlined data entry; and/or (iv) a graphical display of parameters (e.g., history, meters, bar graphs, etc.).

For example, the user-interface I/O modules 612, 614 embodied as a video display unit (VDU) driver module and an input driver module, respectively. The input driver module may be adapted to exchange input data from an input device, such as a keyboard, keypad, a pointing device, a stylus, etc., to provide the user-friendly access to features of the DCC device 310 and to provide streamlined data entry. The VDU driver module may be adapted to drive a video display for providing the simultaneous display of vehicle data and other information and/or graphical display of the vehicle data and other information.

Each of the I/O communication ports 616, 618 may be configured to communicate according to a standard or proprietary communication protocol so as to provide an interface for coupling the respective communications interface adapters 622(a)-622(c), 624(a)-624(c) to the scan tool 600. For instance, the I/O communication port 616 may be adapted to communicate with the communications interface adapters 622(a)-622(c) according to a CompactFlash™ Type-1 or 2 protocol. The I/O communication port 618 may be adapted to communicate with the communications interface adapters 624-(a)-624(c) according to a PCMCIA Type-1 or 2 protocol.

Accordingly, the communications interface adapters 622(a)-622(c), 624(a)-624(c) may be adapted to communicate with the I/O communication ports 616, 618, respectively. Continuing with the above example, the communications interface adapters 622(a)-622(c) may be in the form of a CompactFlash™ Type 1 or 2 protocol adapter (commonly referred as a CompactFlash™ card). The communications interface adapters 624(a)-624(c) may be in the form of a personal computer memory card international association (“PCMCIA”) Type-1 or 2 protocol adapter (commonly referred as a PCMCIA card).

The communications interface adapters 622(a)-622(c), 624(a)-624(c) may also be adapted to capable of carrying out communications with the VIM 114 in accordance with most any communication protocol, including the communication protocols noted above. For example, each of the communications interface adapters 622(a) and 624(a); 622(b) and 624(b), 622(c) and 624(c) may be any of a BluetoothTM, IEEE 802.11 et seq., IEEE 802.15 , Zigbee, IEEE 802.16 , or other WLAN, WPAN, UWB, and BWA network compliant controller. As shown in FIG. 6, the communications interface adapters 622(a) and 624(a); 622(b) and 624(b), 622(c) and-624(c) are Bluetooth™-compliant controllers, IEEE 802.11 et. seq. compliant controllers, and IrDA-compliant controllers, respectively.

When inserted in the respective I/O communication ports 616, 618, the communications interface adapters 622(a) and/or 624(a) are operable to equip the scan tool 600 with Bluetooth™ connectivity. Similarly, the communications interface adapters 622(b) and/or 624(b) are operable to equip the scan tool 600 with IEEE 802.11 et. seq. connectivity when inserted in the respective I/O communication ports 616, 618. The communications interface adapters 622(c) and/or 624(c) are operable to equip the scan tool 600 with IrDA connectivity.

As an alternative to removable wireless networking controllers, the scan tool 600 may employ a communications interface adapter (not shown) embodied as a hard-wired, non-removable wireless network controller. The deployment of the scan tool 600 with such wireless network controller may (i) reduce the cost of manufacture of the scan tool 600, (ii) improve the structural integrity of the scan tool 600, and (iii) improve the internal power consumption of the scan tool 600 as compared to the scan tool 600 not possessing such wireless network controller.

The above-described architecture of the scan tool 600 is for exemplary purposes only. Other embodiments and/or more or less components of the scan tool 600 may be used as well.

5. An Exemplary Compilation of Display Screens

FIG. 7 is a block diagram illustrating an example of a compilation of screen shots 702-712 of a display of a DCC device carrying out a servicing event of a vehicle, such as vehicle 130. Although the compilation of screen shots 700 may be provided by different architectures and operations, the following is described with reference to the system 300 for simplicity.

In this embodiment, the DCC device 310 may be embodied as any of the scan tool 600. The VIM 114 may be configured as the single contact point for obtaining the vehicle information. The network server 204 may be embodied as web server. The vehicle-communication link 328 may be embodied as a WLAN. And the communication networks 112, 116 may be embodied as WLANs integrated with public networks, such as the Internet. Furthermore, the user may be a vehicle service technician.

After the scan tool 600 or the service technician ascertains that the scan tool 600 lacks the particular vehicle information, then the processor 602 causes the user-interface output module 614 to output to the display of the scan tool 600 the screen shot 702. The screen shot 702 includes (i) a first GUI part 702(a) that indicates that the scan tool 600 lacks the particular vehicle information; (ii) a second GUI part 702(b) that indicates that one or more of the communications interface adapters 622(a)-622(c), 624(a)-624(c) are available for effectuating a communication with the VIM 114; and (ii) a third GUI part 702(c) that indicates that the scan tool 600 may exit the servicing event.

After a selection of the communications interface adapter 622(a), for example, the scan tool 600, using the selected adapter 622(a), attempts to establish a connection with the VIM 114 via an access point to the first communication network 112 in accordance with the protocol of the WLAN. If, however, the communications interface adapter 622(a) is unable to connect with the access point or other portion of the first communication network 112, the processor 602 causes the user-interface output module 614 to output to the display of the scan tool 600 the screen shot 704. The screen shot 704 includes a GUI part 704(a) that indicates that the communications interface adapter 622(a) failed to connect with the access point or other portion of the first communication network 112.

After a given amount of time or after user interaction, the scan tool 600 redisplays screen 702 to allow selection or reselection of one of the communications interface adapters 622(a)-622(c), and 624(a)-624(c). Until one of the communications interface adapters 622(a)-622(c), and 624(a)-624(c) connects with the access point and other portions of the first communication network 112 or until the scan tool 600 exits from the servicing event 702, the scan tool 600 may display and redisplay screens 702 and 704.

After establishing a connection, the scan tool 600 may establish, using generally known techniques, the point-to-point conduit with the network server 204. And after the point-to-point conduit is established, the scan tool 600 may then send to the network server 204 the vehicle-information request.

Responsive to the vehicle-information request, the scan tool 600 receives from the network server 204 the interrogation request to interrogate the scan tool 600 to determine the current version of vehicle application and/or content possessed by the scan tool 600. The interrogation request may be formatted in accordance with most any communication signaling and/or messaging protocol. For simplicity, however, this interrogation request may be in the same format as the first request from the scan tool 600.

In response to an automatic or user selected affirmative reply to the interrogation request, the network server 204 interrogates the scan tool 600 to determine the current version of the vehicle application and/or content. To facilitate this interrogation, the network server 204 may (i) download to the scan tool 600 (usually after approval from the scan tool 600) a query application to scan the ROM 604, NVRAM 606, and/or RAM 608 to obtain the current versions (and possibly, version numbers) of the vehicle application and/or content, and (ii) cause the processor 602 to execute the downloaded query application.

While the query application interrogates the scan tool 600, the processor 602 causes the user-interface output module 614 to output to the display of the scan tool 600 the screen shot 706. After scanning the ROM 604, NVRAM 606, and/or RAM 608, the processor 602 via the query application may send to the network server 204 the current versions (and/or version numbers) of the vehicle application and/or content.

The network server 204, using the current versions (and/or version numbers) of the vehicle application and/or content obtained via the query application, may query itself and/or one or more of the vehicle information provide servers 330-334 to locate obtainable versions of the vehicle application and/or content that include the particular vehicle information. After locating the obtainable versions of the vehicle application and/or content, the network server 204 may acquire for distribution to the scan tool 600 the obtainable versions of the vehicle application and/or content.

In turn, the network server 204 sends to the scan tool 600 via the query application the obtainable versions of the vehicle application and/or content. The query application then completes, unloads from the NVRAM 606 and/or RAM 608, and is typically deleted from the scan tool 600. The query program, however, may be stored in the NVRAM 606 for later retrieval and use.

The processor 602 then causes the user-interface output module 614 to output to the display of the scan tool 600 the screen shot 708. This screen shot 708 may includes an almost limitless number of GUI parts to indicate the obtainable versions of the vehicle application and/or content that are available for download. As illustrated, however, the screen shot 708 includes eight GUI parts, namely GUI parts 708(a)-708(h), for simplicity.

The screen shot 708 also includes GUI notations, namely GUI notations 708(i), 708(j), which are used to indicate a charge for downloading the obtainable versions of the vehicle application and/or content. As illustrated, GUI notation 708(i) indicates that the obtainable versions of the vehicle application and/or content listed in the GUI parts 708(a)-708(d) are free of charge. On the other hand, GUI notation 708(j) indicates that the obtainable versions of the vehicle application and/or content listed in the GUI parts 708(e)-708(h) have an associated fee for download.

After selection of any of the obtainable versions of the vehicle application and/or content listed in the GUI parts 708(e)-708(h), the network server 204 may send the service-validating request to substantiate that the scan tool 600 has paid for the obtainable versions of the vehicle application and/or content selected via the user interface. Like above, the service-validating request may be formatted in accordance with most any communication signaling and/or messaging protocol. For simplicity, however, this service-validating request may be in the same format as the first request.

To facilitate obtaining the service-validating information from the scan tool 600, the processor 602 may cause the user-interface output module 614 to output to the display of the scan tool 600 the screen shot 710. The screen shot includes a various number of GUI parts 710(b) for obtaining service-validating information, such user name and password for a subscription arrangement. Via the user interface and the user-interface input module 616, the processor 602 may receive the service-validating information.

If, however, the scan tool 600 cannot substantiate that it has paid for obtainable versions of the vehicle application and/or content selected, the network server 204 (or a proxy thereof) is operable to obtain payment from the scan tool 600 by employing a fee arrangement, such as the fee arrangements noted above. To facilitate payment, the processor 602 may cause the user-interface output module 614 to output to the display of the scan tool 600 the screen shot 710, which includes a various number of GUI parts 710(b) for obtaining service-validating information, such as credit information.

After ensuring that the scan tool 600 has paid for the selected obtainable versions of the vehicle application and/or content or after selecting obtainable versions of the vehicle application and/or content that are free of charge, the network server 204 may then download or otherwise send such versions of the vehicle application and/or content to the scan tool 600 via the point-to-point protocol conduit. After completion of this download, the scan tool 600 may, as appropriate, install, update or otherwise incorporate into (e.g., by replacement and/or modification of) its current version of the vehicle application and/or content the vehicle application and/or content obtained from the network server 204.

After completion of the download and installation, the processor 602 causes the user-interface output module 614 to output to the display of the scan tool 600 the screen shot 712. The screen shot 712 includes a first GUI part 712(a) that indicates that the vehicle application and/or content obtained from the network server 204 is installed and ready to use. The screen shot 712 also includes a second GUI part 712(b) that indicates that the scan tool is available for carrying out the servicing event.

After receiving an input to carry out the servicing event via the user-interface input module 616, the processor 602 may direct the I/O communication port 620, via the vehicle adapter, to communicatively couple to the internal-communication links 326(a)-326(c) and the vehicle-communication link 328. Thereafter, the scan tool 600 may interrogate the OBD device 322 and vehicle systems 324(a)-324(b) to obtain the select vehicle data. The scan tool 600 may then analyze one or more conditions of the vehicle 130 as a function of the select vehicle data and at least a portion of the particular vehicle information obtained from the network server 204. In turn, the scan tool 600 may send a result of the analysis to the user interface for display on the GUI.

6. Conclusion

Variations of the system and method described above are possible without departing from the scope of the following claims. For example, the aforementioned logic may be run locally on proprietary equipment owned or leased by various users, e.g., fleet managers, vehicle distributors, vehicle dealers and the like. The logic may be embodied as a stand alone or alternatively a distributed software application. Also, the logic may include software and/or firmware code or instructions for carrying out freely available and/or proprietary web browsers and the like for communicating with the vehicle-information marketplace.

Further, the VDS may be incorporated in whole or in part in the OBD units and/or vehicle systems, thereby obviating the need for a separate VDS. Accordingly, the OBD units and/or vehicle systems can be equipped with, for example, a bar code scanner and/or other human user interface to facilitate data capture. Note also that one or more additional servers can also be incorporated into the system to, for example, accommodate additional data management functions and/or provide interfaces for integrating with the vehicle application and/or logic of the VDS.

The vehicle information obtained via the vehicle application can be used to, for example, re-calibrate vehicle components, perform firmware downloads, perform component failure analysis, determine wear characteristics, analyze quality of components used in their manufacturing processes, retrieve and manage warranty information, receive indications of vehicle maintenance needs, monitor vehicle use and abuse, and/or monitor lessee trip information, perform proactive data analysis, perform pre-arrival diagnostics, re-calibrate vehicle components, and/or perform firmware downloads. Note that this list of options is not exhaustive and those of skill in the art will understand that other variations in the data obtained via the system, and how the data is presented and used can vary without departing from the scope of the following claims.

Moreover, the exchanges between (i) the VDS and the VIM, (ii) the VDS and the vehicle, and (iii) the vehicle and VIM may be carried out using synchronous or asynchronous techniques and may be carried out in real time, near-real time or in any other time frame. In real time each of the exchanges receives an immediate response such that the information is received so as not to delay processing. In near-real time, each of the exchanges receives a response such that the information is received so as to not substantially delay processing or significant degrade a performance of the processing systems.

As described above, the communications between the VDS and the VIM and the VDS may be carried out in accordance with any 1G, 2G, 2.5G and 3G telecommunication protocol, which may include any the commonly used protocols, such as Advanced Mobile Phone Service (AMPS), Time Division Multiple Access (TDMA), Global System for Mobile Communications (GSM), and Code Division Multiple Access (CDMA), Universal Mobile Telecommunications Service (“UMTS”), Wide-band CDMA (“WCDMA”), ultra wideband CMDA, CDMA2000, Generic Packet Radio Services (“GPRS”), Telecommunications Industry Association's (TIA) IS-94 specifications, and any combination or variation thereof.

Further, the vehicle systems and other vehicle mounted devices may include or be utilized with any appropriate voltage source, such as a battery, an alternator and the like. The voltage source may provide any appropriate voltage, such as about 12 Volts, about 24 Volts, about 42 Volts and the like.

Also, the embodiments described herein may be used with any desired system or engine. These systems or engines may utilize (i) fossil fuels, such as gasoline, natural gas, propane and the like; (ii) electricity, such as that generated by battery, magneto, solar cell and the like; (iii) wind and hybrids; and/or (iv) combinations thereof Those systems or engines may be incorporated into other systems, such as an automobile, a truck, a boat or ship, a motorcycle, a generator, an airplane and the like.

In addition, the computing platforms, systems, controllers, and other devices containing processors described herein may contain at least one Central Processing Unit (“CPU”) and a memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.” One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the described methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It should be understood that the exemplary embodiments are not limited to the above-mentioned memories and that other platforms and memories may support the described methods.

Further, the claims should not be read as limited to the described order or elements unless stated to that effect. In addition, use of the term “means” in any claim is intended to invoke 35 U.S.C. §112, and any claim without the word “means” is not so intended.

We claim:

1. A system for providing access to diagnostic information associated with a function of a vehicle, the system comprising a network server adapted to:
receive from a vehicle-diagnostic system a request for particular vehicle information;
provide to an information-retrieval engine the first request;
receive from the information-retrieval engine an indication of whether the particular vehicle information has been located;
receive from the information-retrieval engine the particular vehicle information; and
provide to the vehicle-diagnostic system the particular vehicle information.

2. The system of claim 1, further comprising the vehicle-diagnostic system, wherein the vehicle-diagnostic system is capable of obtaining vehicle diagnostic data associated with an operation of the vehicle.

3. The system of claim 1, further comprising the information retrieval engine.

4. The system of claim 3, wherein the information-retrieval engine is adapted to receive the first request from the network server, obtain from at least one vehicle the particular vehicle information, and provide to the network server the particular vehicle information.

5. The system of claim 2, wherein the vehicle-diagnostic system comprises a diagnostic and command-and-control (DCC) device.

6. The system of claim 5, wherein the DCC comprises a computing platform, wherein the DCC is communicatively coupled to the vehicle, and wherein the DCC comprises logic to
(i) obtain, via an interface that is communicatively coupled to the vehicle, select-vehicle data associated with an operation of the vehicle;
(ii) ascertain that the computing platform lacks particular vehicle information for analyzing the vehicle diagnostic data; and
(iii) generate a request for desired vehicle information corresponding to the particular vehicle information.

7. The system of claim 1, further comprising a billing system that is adapted to communicate with at least one billing server via the network server.

8. The system of claim 7, wherein the network server is adapted to charge a fee for the particular vehicle information, wherein the network server is adapted to determine the fee associated with the particular vehicle information and provide one or more billing options to the user interface, wherein the user interface is adapted to generates a billing request in response to the billing options, and wherein the billing system is adapted to processes the billing request.

9. The system of claim 8, wherein the billing options comprise a first option for charging the fee to a credit account, a second option for charging the fee to a debit account, a third option for charging the fee to a checking account, and a fourth for charging the fee to a savings account.

10. The system of claim 8, further comprising a customer account database that is adapted to communicatively couple to the billing system, wherein the customer account database includes a customer account having details for covering a fee for the particular vehicle information, and wherein the billing options comprise a first option for charging the fee to a customer account in accordance with the details contained in the customer account database.

11. The system of claim 10, wherein the network server is adapted to determine the fee associated with the particular vehicle information by retrieving customer account information from the customer account database, determining a level of access associated with the customer account information, and calculating a fee for the selected vehicle information beyond the level of access.

12. The system of claim 1, wherein the at least one vehicle information providers comprise vehicle original equipment manufacturer websites.

13. A method for providing to a vehicle-diagnostic system diagnostic information associated with a function of a vehicle , the method comprising:
receiving a request for particular vehicle information from the vehicle-diagnostic system;
locating the particular vehicle information;
requesting from the vehicle-diagnostic system service-validating information to substantiate payment for the particular vehicle information;
determining whether the vehicle-diagnostic system has provided service-validating information;
retrieving the particular vehicle information; and
providing to the vehicle-diagnostic system the particular vehicle information when the vehicle-diagnostic system provides the service-validating information.

14. The method of claim 13, further comprising:
determining fees associated with the particular vehicle information; and
incorporating the fees into the particular vehicle information.

15. The method of claim 14, further comprising:
generating payment options;
presenting the payment options to the vehicle-diagnostic system;
receiving from the vehicle-diagnostic system a request for payment; and
processing the request for payment.

16. The method of claim 15, wherein the particular vehicle information is provided to the vehicle-diagnostic system after processing the request for payment.

17. The method of claim 15, wherein the payment options comprises any of a payment by credit account, payment by checking account, and payment by savings account.

18. The method of claim 15, wherein the payment options comprises payment by a user account.

19. The method of claim 13, further comprising formatting the particular vehicle information to conform to at least one capability of the vehicle-diagnostic system.

20. The method of claim 13, wherein locating the particular vehicle information comprises:
searching a cache for the particular vehicle information; and
searching one or more vehicle information providers for the particular vehicle information.
